(19) United States
(12) Patent Application Publication
(10) Pub. No.: US 2002/0078224 A1
(43) Pub. Date: Jun. 20, 2002

(54) Communication system with automatic transmission rate determination

(75) Inventors: Dieter Brueckner, Unterleiterbach (DE); Juergen Seiter, Baden-Baden (DE); Michael Tremel, Nuernberg (DE)

Correspondence Address: SUGHRUE MION, PLLC, 2100 Pennsylvania Avenue, NW, Washington, DC, 20037-3213, US

(73) Assignee: SIEMENS AG

(21) Appl. No.: 09/987,359

(22) Filed: Nov. 14, 2001

Related U.S. Application Data
(63) Continuation of application No. PCT/DE00/01499, filed on May 12, 2000.

(30) Foreign Application Priority Data
May 14, 1999 (DE) DE 29908608.9

(51) Int. Cl. G06F 15/16

(52) U.S. Cl. 709/233; 709/250

(57) ABSTRACT

A network communication system having a number of independent subscribers (8 . . . 10) connected to the network through corresponding coupling devices (11 . . . 13) is able to rapidly propagate the transmission rate of each data message sent between subscribers and thereby efficiently control the receiving devices on the network to receive the data messages at their transmitted rate. Coupling devices (11 . . . 13) are able to recognize the rate at which each transmitted message is sent and prepare a special message to be sent to each of the other receiving devices on the network. The special message contains information regarding the transmission rate of the data messages and is used to control the receiving devices reception rate.

This is a Continuation of International Application PCT/DE00/01499, with an international filing date of May 12, 2000, which was published under PCT Article 21(2) in German, and the disclosure of which is incorporated into this application by reference.

### FIELD OF THE INVENTION

The present invention relates generally to a network communication system having a number of independent subscribers connected to the network through corresponding coupling devices. More particularly, the present invention relates to a network communication system where the transmission rates of each transmitted data message can be automatically propagated to each device on the network. The invention additionally relates to a coupling device and a subscriber device that can each send and receive a special message containing the data rate of a message and a method for sending and receiving this information.

### BACKGROUND OF THE INVENTION

In asynchronous data transmission, whether baseband or modulated, the subscriber units connected to a network do not have a common clock. For data transmission, however, a receiving subscriber unit must be able to reconstruct a transmitted bit sequence from a received signal. To this end, signal acceptance at the subscriber must be synchronous with the transmission of the data at the sender. To adequately perform this task, a clock is required. The clock is used to determine the points in time where the data signal is valid and it is dependent on a transmission rate, which is typically measured in bits per second. For the data to be correctly transmitted between the subscribers in the network, the transmission rates set at the subscriber units must consequently match. Field buses in particular, described for instance in German Application DE 44 18 622 A1, frequently offer several transmission rates for selection. To synchronize the data transmission, the same transmission rate must be set at each subscriber unit. In small networks, this can be done manually by means of manual or software switches, the coding of which corresponds to the transmission rate and is read by a suitably programmed microprocessor. However, particularly in networks with optical signal transmission, coupling devices used to connect segments of the network and subscribers are located physically far apart from one another. Accordingly, manual adjustment of a new transmission rate is very costly and time consuming.

The aforementioned German Application DE 44 18 622 A1 describes a method for determining the transmission rate in a network which is intended to avoid this inefficiency and cost. In the German Application, the subscriber unit, which monitors the transmission signal without being active on the bus, infers the transmission rate from the distance between two signal edges. Although this distance is a function of the number of bits that lie between the edges, there are distance values that can be unambiguously assigned to a transmission rate. If assignability of the measured value is ambiguous, a set of transmission rates is obtained. If several sets are determined by evaluating several measured values, it is often possible to form a cut set therefrom, which permits an unambiguous determination of the transmission rate. This type of determination of the transmission rate is also used in coupling devices, where it is called a repeater. These coupling devices connect segments of the network and output signals, which have been received on a segment, in an amplified manner to the other connected segments.

To prevent propagation of faults over the entire network, the repeater outputs are cleared only if a measured value that can be unambiguously assigned to a transmission rate is detected, and, further, when at least three successive measured values that can be unambiguously or ambiguously assigned to the same transmission rate are detected. If, in the interim, no three successive measured values that can be unambiguously or ambiguously assigned to the detected transmission rate are observed, there is a wait period that lasts until a measured value that can be unambiguously assigned is found.

In a cleared coupling device, the process according to the German Application can always run in the background during operation in order to detect any resetting of the transmission rate and, if required, to switch the device's own transmission rate. To this end, an error counter is increased by one as soon as the measurement results in an unambiguous assignment to a transmission rate other than the one currently set. Each measurement resulting in an unambiguous assignment to the currently set transmission rate lowers the error counter by one. None of the other measured values affect the error counter. As soon as the error counter has reached the value 32, the above-described process for determining the transmission rate is restarted and the error counter is reset.

The drawback to the method described in the prior art reference discussed above is that several messages are required to detect a change in the transmission rate and to determine the new transmission rate. Moreover, the time required cannot be predicted since it depends on both the previous and the new transmission rates as well as the transmitted messages.

In addition, a coupling device can forward messages to downstream coupling devices only if the coupling device itself has detected and set the new transmission rate. Only then can the coupling devices connected downstream detect and set the new transmission rate. The propagation of a new transmission rate over the entire network therefore requires a substantial amount of time if many coupling devices are connected in series. Any messages that are transmitted during this time are lost and fail to reach the receiver.

### OBJECTS OF THE INVENTION

One object of the present invention is to create a network that will adjust more rapidly than presently available systems to a new transmission rate. A further object of the present invention is to create a novel coupling device for connecting two segments in a network and a novel subscriber unit for connection to a segment of a network. Both the connection device and the subscriber unit should provide for rapid propagation or setting of a new transmission rate.

### SUMMARY OF THE INVENTION

According to one formulation of the invention, a communication system is provided that comprises a plurality of subscribers which are each operable to transmit regular data messages to another subscriber and can also receive regular data messages from another subscriber. The system also includes a plurality of coupling devices which are operably connected to the subscribers, wherein each of the coupling devices corresponds to a respective subscriber. Also included with this formulation of the invention is a communication medium operably connected to each of the coupling devices. The medium is capable of bidirectionally transmitting regular data messages between the coupling devices wherein at least one of the coupling devices is operable to directly determine a transmission rate of a transmitted regular data message and prepare a special data message which includes the determined transmission rate.

In accordance with embodiments of the present invention, a newly set transmission rate is propagated from a subscriber via a coupling device to other connected coupling devices or subscribers much more rapidly than in current networks. Since the subscribers or coupling devices that are connected downstream receive the transmission rate determined in the first coupling device in a special message as information, the subscribers or coupling devices are able to determine and set the data rate by evaluating a single message. This ensures considerably faster propagation and, in addition, a more predictable propagation time of a new transmission rate over one coupling device.

If all coupling devices are able to generate special messages that contain the new data rate as information, and if all are able to receive such special messages and set their receiving devices for regular data traffic messages to a data rate contained as information in a received special message, a new data rate is rapidly propagated over the entire network. Similarly to a broadcast message addressed to all subscribers in the network, a received special message can be transmitted to all downstream coupling devices or subscribers to forward the new data rate.

### BRIEF DESCRIPTION OF THE DRAWINGS

The invention as well as embodiments and advantages thereof are described below in greater detail, by way of example, with reference to the drawings in which:

FIG. 1 shows detail of a network;

FIG. 2 shows the principle structure of a subscriber unit in accordance with the present invention; and

FIG. 3 is a block diagram of a coupling device in accordance with the present invention.

### DETAILED DESCRIPTION OF THE PREFERRED EMBODIMENTS

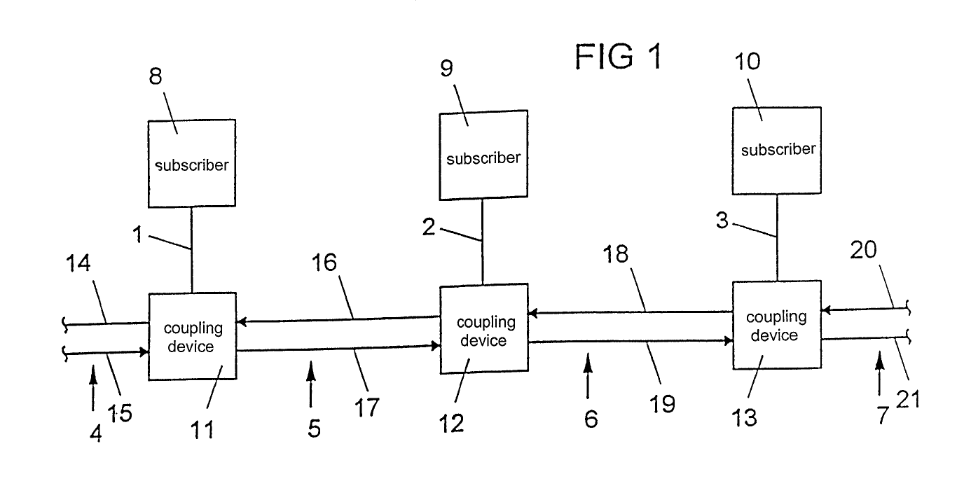

As shown in FIG. 1, a network comprises transmission segments 1, 2 and 3 upon which data is transmitted with electrical signals, and segments 4, 5, 6 and 7 with optical signal transmission. Other types of transmission media are known in the art and can be used in segments 1-7. Only a part of a representative network is illustrated in FIG. 1. Subscribers 8, 9 and 10 are connected by segments 1, 2 and 3 to coupling devices 11, 12 and 13, respectively. Other coupling devices and corresponding subscribers (not shown for the sake of clarity) can be placed to the left of segment 4 and to the right of segment 7. Segments 4, 5, 6 and 7, using optical signal transmission, have optical waveguides for transmitting optical signals bi-directionally between coupling devices 11-13. For segment 4, the waveguides are optical waveguides 14 and 15; for segment 5, optical waveguides 16 and 17; for segment 6, optical waveguides 18 and 19; and for segment 7, optical waveguides 20 and 21. Arrowheads designate the transmission direction on each of the respective waveguides. Segments 1, 2 and 3 in this exemplary embodiment are built to the RS485 specification. However, other communication standards, such as, RS232, RS-422, current loop, and fiber optics, can be used as well. According to this embodiment, data transmission on these segments is based on the PROFIBUS DP protocol, although other protocols could be used as alternatives.

The network can be operated at several different data rates. If all network components are set to operate at the same data rate, any transmitted messages can be exchanged between subscribers 8, 9 and 10, as desired. For instance, if subscriber 8 sends a message on segment 1, coupling device 11 receives this message and routes it onward using optical signals to optical waveguides 14 and 17 (i.e., the outgoing waveguides of coupling device 11) of segments 4 and 5. At the other end of segment 5, coupling device 12 receives the message coming in on optical waveguide 17 and passes it to segments 2 and 6.

Thus, coupling device 13 also receives the message from optical waveguide 19 of segment 6 and relays it to segments 3 and 7. As described in greater detail in the RS485 specification, incorporated herein by reference, the messages circulating in the network each have a destination address by which each subscriber seeing the message can determine whether or not the message is intended for it. If, for instance, subscriber unit 8 is set for operation using a different transmission rate, or if subscriber unit 8 constitutes a new, previously unconnected, subscriber with a new transmission rate, subscriber 8 first sends a message at the new transmission rate which is different from the one set in coupling devices 11, 12 and 13 and subscribers 9 and 10. Since subscribers 9 and 10 and coupling devices 11, 12 and 13 are, therefore, not synchronized to the new transmission rate, they cannot correctly receive the messages from subscriber 8.

Coupling device 11 is configured in such a way that it can determine the data rate used for a transmitted message by analyzing messages received on segment 1. Once the data rate of messages on segment 1 has been identified, coupling device 11 generates special messages, which contain the previously determined data rate as information, and transmits these special messages on optical waveguides 14 and 17 of segments 4 and 5, respectively. At the same time, coupling device 11 sets its components that are provided for the regular message traffic within the network to the new transmission rate.

Coupling device 12, which receives the special message containing the new transmission rate from optical waveguide 17, relays the special message to optical waveguide 19 of segment 6 as well as to segment 2. Furthermore, coupling device 12 evaluates the special message and also sets the data rate of its components for regular message traffic to the new data rate.

The special message is transmitted within the network at a fixed transmission rate, which is identical for all network components. The mode of operation of coupling device 13 is analogous to that of coupling device 12, so that the special message reaches the subscriber 10 via segment 3. When subscribers 9 and 10 receive the special message, they also set their components that are required for regular communication within the network to the new transmission rate. The described exemplary embodiment clearly illustrates that a new transmission rate will rapidly propagate to all components in the network.

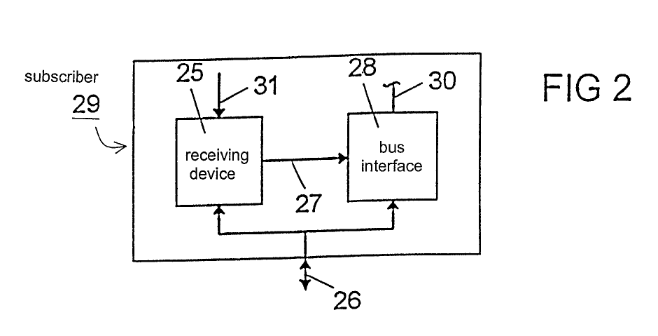

FIG. 2 is a block diagram illustrating an exemplary embodiment of a subscriber unit 29, showing the essential components of a communication device in accordance with the present invention. Additional application-specific circuit elements of the subscriber unit are not depicted for the sake of clarity.

The communication device 29 has a receiving device 25, which is set to a fixed predefined data rate. This fixed predefined data rate, which is used to transmit special messages, is identical in all the components of the network (e.g., subscriber units 8-10 and coupling devices 11-13). Thus, receiving device 25 is always able to receive and evaluate the previously mentioned special messages from a segment 26 acting as a channel. As mentioned, these special messages contain the data rate at which regular data traffic messages are transmitted within the network. This data rate is determined by evaluating the special message in the receiving device 25 and is indicated by a signal 27 to a bus interface 28. Bus interface 28 can be set to operate at different data rates and accepts the data rate indicated by signal 27. Bus interface 28 transmits and receives regular data traffic messages within the network at the accepted data rate on segment 26. Also, any necessary data exchange between application-specific circuit elements (not shown) of subscriber 29 and bus interface 28 can be effected via line 30.

The network, in principle, can be operated even if no receiving device 25 is provided in subscriber unit 29 for the fixed predefined transmission rate. In this case, it must be possible to set the bus interface of such a subscriber to a new transmission rate in some other manner. According to a further embodiment, this is accomplished by means of a device for determining the transmission rate, such as the one described in the aforementioned German Application DE 44 18 622 A1. A bus interface with such a device can of course also be combined with a receiving device 25 for a fixed predefined transmission rate.

The receiving device 25 of subscriber 29 is furthermore configured to generate a special message if the data rate that is currently being used for regular data traffic within the network must be changed. The need to change the data rate is indicated to the receiving device 25 by a signal 31. This special message contains the new data rate as information. The special message is transmitted to the other components, which are connected to segment 26, at the fixed predefined data rate. This ensures rapid adjustment of the network to a new transmission rate for the regular data traffic. Such a change in the data rate currently used in the network for the regular data traffic can, for instance, be entered manually via an input device (not shown) of subscriber unit 29 and be communicated to receiving device 25 via signal 31.

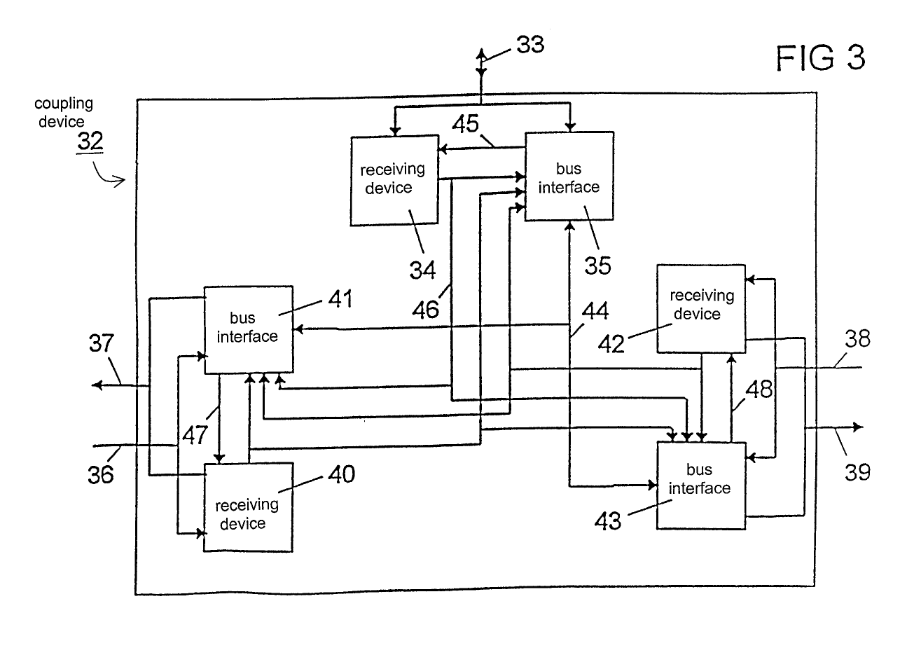

FIG. 3 shows exemplary components of a coupling device 32, which serves to connect a subscriber unit, such as subscriber 29, with an electrical channel to a bus system supporting optical signal transmission. A subscriber unit capable of transmitting electrical signals can be connected to a line 33, which leads to a receiving device 34 and a bus interface 35 in coupling device 32. Additional coupling devices (not shown) may be connected, respectively, to an optical channel having an optical waveguide 36 and an optical waveguide 37 for the two transmission directions and an optical channel with an optical waveguide 38 and an optical waveguide 39. In the coupling device, the optical waveguides 36 and 37 are connected to a receiving device 40 and a bus interface 41, while the optical waveguides 38 and 39 are connected with a receiving device 42 and a bus interface 43. The operation of the receiving devices 34, 40 and 42 is essentially the same and the same is the case for the operation of the bus interfaces 35, 41 and 43. Thus, a description of the receiving device 34 and the bus interface 35 alone should suffice to describe the functioning of the coupling device 32 as a whole.

Regular incoming data traffic messages on segment 33 are received in bus interface 35 at a correctly set data rate and are relayed via a line 44 to bus interfaces 41 and 43, which output the messages to the optical waveguides 37 and 39, respectively. Also provided in bus interface 35 is a device (not shown) for determining the data rate of incoming messages. This device is known from the aforementioned German Application DE 44 18 622 A1.

If the data rate of a message received on segment 33 differs from the currently set data rate of bus interface 35, the new data rate is set in bus interface 35 only after the new data rate is actually determined. The process of determining the new data rate may require the input of several data messages. When the new data rate has been identified, the bus interface 35 provides the new data rate to the receiving device 34 by a signal 45. The receiving device 34, with a signal 46, forwards the new data rate to bus interfaces 41 and 43, which consequently also adjust to this new transmission rate. In addition, bus interfaces 41 and 43 indicate any change in the transmission rate to the respectively assigned receiving devices 40 and 42 by means of signals 47 and 48. Receiving devices 40 and 42 then generate a special message containing the new transmission rate as information on the optical waveguides 37 and 39, respectively. This special message is transmitted at a fixed predefined data rate to the other connected coupling devices, which are thus informed of the new transmission rate in the network shortly after coupling device 32 identifies the change in the transmission rate.

A faster option to switch the coupling device 32 itself to a new data rate occurs when a special message is received from segment 33. The receiving device 34 is set to a fixed predefined data rate that matches the data rate of the special message. The receiving device 34 constantly monitors the message traffic on segment 33 and can thus always correctly receive and evaluate the special messages transmitted on segment 33. By means of signal 46, the receiving device 34 again indicates the new data rate to the bus interfaces 35, 41 and 43, which are then adjusted to the new transmission rate shortly after receiving the special message. Corresponding special messages are then generated in receiving devices 40 and 42 for any additional coupling devices that may be connected to the optical waveguides 37 and 39.

The model of a coupling device 32 illustrated by FIG. 3 serves merely for a better understanding of its mode of operation. FIG. 3, for example, does not depict, for the sake of clarity, a control unit, which, after detection of the first incoming message on one of the three connected segments, can block the other two segments to prevent collisions. In a modification of the block diagram depicted in FIG. 3, a coupling device can also have only one receiving device and one bus interface, upstream of which a switch is then connected to select the receiving channel upon which an incoming message has first been detected and downstream of which a switch is connected to select the output channels to which the incoming message is to be forwarded. In this case, only the receivers and drivers for the corresponding physical signals are assigned to the individual channels.

With the use of a bus interface, which in addition to receiving regular data traffic messages at one of the various possible transmission rates, is also capable of continuously receiving special messages at a fixed predefined data rate, a separate receiving device for the special messages may be eliminated. In this case, the receiving device is integrated into the bus interface.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A network comprising a plurality of subscribers, said network being divided into a plurality of segments connected with one another by at least one coupling device, wherein said coupling device is configured to determine from a received message, a data rate used for transmitting the message,
wherein said first coupling device generates a special message which contains a previously established data rate as information, and sends the special message at a fixed predefined data rate to neighboring subscribers or coupling devices,
wherein at least one of the neighboring subscribers or coupling devices has a receiving device and a bus interface for the same channel, the receiving device being set to the fixed predefined data rate of the special message and the bus interface being adjustable to be set to different data rates, and
wherein the receiving device and the bus operate in such a way that the data rate of the bus interface is set to the data rate that is contained as the information in the special message received by the receiving device.

2. A network as claimed in claim 1, comprising a plurality of further coupling devices that operate as the first coupling device.

3. A communication system comprising:
a plurality of subscribers each operable to transmit regular data messages to another subscriber and each subscriber operable to receive regular data messages from another subscriber;
a plurality of coupling devices operably connected to said subscribers, wherein each of said coupling devices corresponds to a respective subscriber;
a communication medium operably connected to each of said coupling devices and capable of bidirectionally transmitting the regular data messages between said coupling devices,
wherein at least one of said coupling devices is operable to directly determine a transmission rate of a transmitted regular data message and generate a special data message which includes the determined transmission rate as information.

4. A communication system as claimed in claim 3, wherein said at least one coupling device transmits the special data message at a fixed transmission rate to at least others of said coupling devices or said subscribers.

5. A communication system as claimed in claim 3, wherein at least one of said subscribers or said other coupling devices comprises a receiving device and a bus interface, wherein the receiving device is operable to receive the special data message at the fixed transmission rate and wherein the bus interface is operable to receive regular data messages at a plurality of transmission rates, including the determined transmission rate.

6. A communication system as claimed in claim 5, wherein a rate at which the bus interface receives regular data messages is controlled to be the determined transmission rate.

7. A communication system as claimed in claim 6, wherein the rate at which the bus interface receives regular data messages is controlled by the receiving device.

8. A communication system as claimed in claim 3, further comprising a plurality of communication segments operably connecting each of said subscribers to a respective coupling device and operable to carry both regular data messages and the special data message.

9. A communication system as claimed in claim 8, wherein said communication segments carry electrical signals.

10. A communication system as claimed in claim 3, wherein said communication medium is a fiber optic medium.

11. A coupling device for connecting a subscriber device of a communication system with a communication medium that carries data messages to and from other subscribers, the coupling device comprising:
a segment coupling section operable to receive and transmit regular data messages from and to a plurality of adjacent coupling devices and further operable to determine a transmit rate of any of the regular data messages received from the adjacent coupling devices, and generate a special data message which includes the determined transmission rate as information;
a subscriber coupling section connected to said segment coupling section and operable to receive and transmit the regular data messages from and to a corresponding subscriber device and further operable to determine a transmit rate of any of the regular data messages received from the corresponding subscriber and generate a special data message which includes the determined transmission rate of the regular data message from the subscriber as information.

12. A coupling device as claimed in claim 11, wherein said segment coupling section comprises:
a plurality of receiving devices each operable to receive the special data message at a fixed transmission rate; and
a plurality of bus interface devices each operable to receive the regular data messages at any transmission rate,
wherein a rate at which said bus interfaces receive the regular data messages is controlled by a corresponding receiving device to be the determined transmission rate.

13. A coupling device as claimed in claim 11, wherein said subscriber coupling section comprises:
a receiving device operable to receive the special data message at a fixed transmission rate; and
a bus interface device operable to receive the regular data message from the corresponding subscriber at any transmission rate and determine the transmission rate at which the regular data message was received,
wherein a rate at which said bus interface receives the regular data message is controlled by said receiving device.

14. A subscriber device for providing a user interface to a communication system, the subscriber device comprising:
a receiving device operable to receive a special data message at a fixed transmission rate, wherein said special data message contains rate information regarding a rate at which a regular data message has been transmitted;
a bus interface device operable to receive regular data messages at any transmission rate; and
a control signal operable to carry control information from said receiving device to said bus interface, wherein the control information includes the rate information.

15. A subscriber device as claimed in claim 14, further comprising:
a receiving device input signal operable to change the fixed transmission rate.

16. A subscriber device as claimed in claim 14, further comprising:
a bus interface device input signal, different than said control signal, operable to provide control information to said bus interface device.

17. A method of controlling transmission rates of regular data messages transmitted in a communication system with a plurality of subscribers connected to a transmission medium through a respective plurality of coupling devices, the method comprising:
transmitting a first regular data message from a first subscriber directed to at least a second subscriber, the regular data message being transmitted at a first transmission rate;
receiving the first regular data message in a coupling device corresponding to the first subscriber;
determining the first transmission rate in the coupling device;
forming a special data message including information regarding the first transmission rate in the coupling device; and
transmitting the special data message to other coupling devices and subscribers at a predefined fixed transmission rate.

18. A method as claimed in claim 17 further comprising:
receiving the special data message in the other coupling devices and subscribers;
determining, from the special data message and in the other coupling devices and subscribers, the first transmission rate; and
setting a rate at which the other coupling devices and subscribers can receive data messages to the first transmission rate.
